(19) United States
(12) Patent Application Publication
(10) Pub. No.: US 2006/0029823 A1
(43) Pub. Date: Feb. 9, 2006

(54) Articles incorporating polyester-containing multilayer coextruded structures

(76) Inventor: Michael Joseph Brown, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/195,484

(22) Filed: Aug. 2, 2005

Related U.S. Application Data
(60) Provisional application No. 60/598,715, filed on Aug. 4, 2004.

(51) Int. Cl. B32B 27/08; B32B 27/36; B32B 1/08

(52) U.S. Cl. 428/480; 428/35.7

(57) ABSTRACT

Disclosed are polyester-containing coextruded or coinjected multilayer structures having at least one opaque interior core layer, having good/desirable interlayer adhesion characteristics and barrier characteristics. Also disclosed are blown bottles and injection molded hollow articles used as bottle preforms comprising these multilayer structures. The bottles are particularly useful for packaging liquids such as milk, other dairy products, and the like.

The application claims priority to U.S. Provisional Application No. 60/598715, filed Aug. 04, 2004, the entire disclosure of which is herein incorporated by reference.

This invention relates to polyester-containing multilayer coextruded or coinjected structures, articles there from such as blown bottles and injection molded hollow articles used as bottle performs, and to packaged products.

### BACKGROUND OF THE INVENTION

The use of polyethylene terephthalate (PET) and similar materials as materials in the formation of numerous injection-molded articles is well known in the art. For example, in the bottle and container industry, the blow molding of injection molded PET preforms has gained wide acceptance. PET materials generally have high strength, high gloss, good clarity, and low gas permeation characteristics and are comparatively easy to recycle.

For some applications, containers made from PET may not provide adequate barriers to, for example, gas and/or moisture permeation into or out of the container. Other needs may include protection of the contents from degradation by visible and/or ultraviolet light. It is desirable to protect milk and other dairy products from visible and UV light and oxygen. One structure known in the art for milk bottles is a white/black/white high-density polyethylene (HDPE) multilayer structure for protection from UV and/or visible light.

Blends of polyester with other polymers may be used to provide improved barrier properties, but they are not suitable for conventional polymer recycling streams. Fillers such as titanium dioxide (TiO₂) can act as delustrants and adversely affect the “sparkle” of the PET.

Alternatively, multilayer structures have been developed to address the needs for improved barrier materials. Other desirable properties in a multilayer package include improved heat distortion and sealing characteristics and flexibility in creating colored packages.

Multilayer structures are often made with polymers having differing compositions that are incompatible with one another. The multilayer structures may therefore exhibit poor adhesion between the various layers, resulting in a poor packaging material. Many compositions under consideration in multilayer packaging are incompatible with polyesters such as PET and/or sufficiently different so they cannot be introduced into conventional polymer recycling streams without separation.

Multilayer structures comprising PET and various performance layers providing improved barrier properties are known. See, e.g., JP Patent 04051423 and Japanese Patent 2663578. See also PCT Publication WO99/58328.

There is a need for multilayer structures with adequate interlayer adhesion and barrier properties during use that can be readily recycled after use. It is also desirable to provide bottles for milk and other dairy products comprising PET with improved protection from visible and UV light and oxygen that can be recycled.

### SUMMARY OF THE INVENTION

The invention provides an article comprising or produced from (a) at least one exterior layer comprising polyester; and (b) at least one substantially opaque interior core layer where the article is substantially opaque and can be a multilayer structure, an injection molded hollow article, a blow molded bottle, or combinations of two or more thereof; the injection molded hollow article can be used as a preform, or parison, for blow molded bottles.

The opaque interior core layers can comprise a second polyester, allowing for a recyclable container in colored polyester recycling streams.

In other embodiments, the opaque core layer can be a barrier material selected from the group consisting of ethylene/vinyl alcohol copolymers, polyvinylidene chloride, polyamides, polyacrylonitrile, aromatic polyesters, resorcinol diacetic acid-based copolyesters, isophthalate-containing polyesters, polyethylene naphthalate (PEN) and its copolymers and mixtures thereof.

A light barrier opaque core can be a polyolefin or an ethylene copolymer that is pigmented. Ethylene methylacrylate is well suited for this application because of its thermal stability and adhesion to PET.

### DETAILED DESCRIPTION OF THE INVENTION

“Monomer” is a relatively simple compound, usually containing carbon and of low molecular weight, which can react to form a polymer by combining with like molecules or with other similar molecules or compounds. “Comonomer” is a monomer that is copolymerized with at least one different monomer in a copolymerization reaction, the result of which is a copolymer. “Polymer” is the product of a polymerization reaction, and is inclusive of homopolymers, copolymers, terpolymers, tetrapolymers, etc. The layers of a structure can consist essentially of a single polymer, or can have additional polymers together therewith, i.e., blended therewith.

“Homopolymer” is a polymer resulting from the polymerization of a single monomer, i.e., a polymer consisting essentially of a single type of repeating unit. “Copolymer” is a polymer formed by the polymerization reaction of at least two different monomers and includes a random copolymer, block copolymer, graft copolymer, or combinations of two or more thereof.

As used herein, terms identifying polymers, such as “polyester”, are inclusive of not only polymers comprising repeating units derived from monomers known to polymerize to form a polymer of the named type, but are also inclusive of comonomers, derivatives, etc., that can copolymerize with monomers known to polymerize to produce the named polymer. Furthermore, terms identifying polymers are also inclusive of blends of such polymers with other polymers of a different type.

“Polyester” includes, for example, PET, polypropylene terephthalate (PPT), polybutylene terephthalate (PBT), a blend of PET, PPT, and/or PBT, a blend of PET, PPT, and/or PBT with additional components including nucleating agent, modifier, toughener (for example PBT and/or PET blends, most preferably PET blends), filler such as TiO₂ or carbon black, or combinations of two or more thereof. Fillers such as TiO₂ are useful as a white pigment to provide opacity for protection from UV and visible light. Similarly, carbon black can be useful as a black pigment to provide opacity of the same purpose.

A polyester composition comprising at least about 65 or about 80 weight % PET can be used. The PET can be a homopolymer or copolymer of PET, i.e., a polymer substantially derived from the polymerization of ethylene glycol with terephthalic acid, or from the ester forming equivalents thereof (e.g., any reactants that can be polymerized to ultimately provide a polymer of polyethylene terephthalate). “Copolymer of PET” includes any polymer comprising (or derived from) at least about 50 mole percent ethylene terephthalate, and the remainder of the polymer being derived from monomers other than terephthalic acid and ethylene glycol (or their ester-forming equivalents). Other comonomers include, for example, di-acids such as succinic acid, adipic acid, azelaic acid, sebacic acid, glutaric acid, 1,10-decanedicarboxylic acid, phthalic acid, isophthalic acid, dodecanedioic acid, and the like; and ester-forming equivalents thereof. Ester-forming equivalents of note are diesters of such acids such as, for example, dimethylphthalate. Other comonomers include, for example, diols such as propylene glycol, methoxypolyalkylene glycol, neopentyl glycol, trimethylene glycol, tetramethylene glycol, hexamethylene glycol, diethylene glycol, polyethylene glycol, cyclohexanedimethanol (CHDM) and the like. Suitable PET compositions for producing blow molded bottles include those available such as Lighter™ from Dow Chemical Company (Dow, Midland, Mich.).

The second polyester can be polyethylene terephthalate, polypropylene terephthalate, polybutylene terephthalate, or combinations of two or more thereof such as at least about 65 weight % or about 80 weight % polyethylene terephthalate homopolymer or copolymer. “(Meth)acrylic acid” means methacrylic acid and/or acrylic acid and “(meth)acrylate” means methacrylate and/or acrylate. The ethylene (meth)acrylic acid and ethylene (meth)acrylate copolymers are sold by E. I. du Pont de Nemours and Company (DuPont, Wilmington, Del.) such as “Nucrel® and Elvalo®” AC.

Polyesters can also be blended with other components such as tougheners. Tougheners include, for example but not limitation, ethylene copolymers including ethylene/alkyl (meth)acrylate copolymers (e.g. ethylene/methyl acrylate), ethylene/alkyl acrylate/glycidyl (meth)acrylate copolymers (e.g. ethylene/n-butyl acrylate/glycidyl methacrylate; i.e., EnBAGMA) and ethylene/ (meth)acrylic acid copolymers and corresponding copolymers partially neutralized with metal ions (i.e., ionomers). Toughened polyesters can comprise from about 3 to about 25, about 3 to about 20, or about 3 to about 15, weight % of one or more tougheners.

Polyesters may be nucleated to improve crystallinity and optical clarity. Nucleating agents may be incorporated into PET to promote temperature resistance. Polyesters with low glass transition temperatures (Tg) can be used as nucleating agents. Suitable nucleation agents also include salts of organic acids, such as sodium stearate.

Non-polyester polymers may be included in the compositions used to prepare the multilayer bottles to provide “pearlesence” upon orientation. For example, the non-polyester polymer may be an ionomeric resin, which are copolymers of an olefin such as ethylene and an unsaturated carboxylic acid, such as acrylic acid, methacrylic acid, or maleic acid, and optionally softening monomers, that have some portion of the acidic groups in the copolymer neutralized with metal ions such as sodium or zinc. Ionomers are sold by DuPont such as “Surlyn®”.

“Inner layer,” “interior layer” and “internal layer” refer to any layer of a multilayer structure having both of its principal surfaces directly adhered to another layer of the structure. “Outer layer” and “exterior layer” refer to any layer of a multilayer structure having less than two of its principal surfaces directly adhered to another layer of the structure. All multilayer structures have two, and only two, outer or exterior layers, each of which has a principal surface adhered to only one other layer of the multilayer structure.

“Inside layer” refers to an outer or exterior layer of a multilayer structure for, for example, fluid transfer that is closest to the fluid relative to the other layers of the multilayer structure. “Inside layer” also refers to the innermost layer of a plurality of concentrically arranged layers simultaneously coextruded through a profile die. An inside layer is used with reference to the layer that forms the surface of the inside of a bottle or preform. “Outside layer” refers to the outer layer of a multilayer structure for fluid transfer that is farthest from the fluid relative to the other layers of the multilayer structure. “Outside layer” also is used with reference to the outermost layer of a plurality of concentrically arranged layers simultaneously coextruded through a profile die. An outside layer is used with reference to the layer that forms the surface of the outside of a bottle or preform.

“Directly adhered”, as applied to layers, is adhesion of the subject layer to the object layer, without an intervening tie layer, adhesive layer, or other layer. In contrast, as used herein, the word “between”, as applied to a layer expressed as being between two other specified layers, includes both direct adherence of the subject layer between to the two other layers it is between, as well as including a lack of direct adherence to either or both of the two other layers the subject layer is between, i.e., one or more additional layers can be imposed between the subject layer and one or more of the layers the subject layer is between.

The term “core” and “core layer”, as applied to multilayer structures, respectively refers to any interior layer that has a primary function other than serving as an adhesive or compatibilizer for adhering two layers to one another. The core layer or layers can provide the multilayer structure with a desired level of strength (i.e., modulus) and/or optics, and/or added abuse resistance, and/or specific impermeability. The term “opaque” means substantially opaque over a wavelength range of interest. For example, in the case of dairy product the wavelength can be up to about 700 nm. “Substantial opaque” means up to 15% of light could be transmitted through the “opaque” layer.

“Tie layer” or “adhesive layer” refer to any interior layer having the primary purpose of adhering two layers to one another. Tie layers can comprise any polymer having a polar group thereon, or any other polymer that provides sufficient interlayer adhesion to adjacent layers comprising otherwise non-adhering polymers.

Tie layer compositions can include those sulfonic acid-derived polyester compositions disclosed above. They may also include blends of sulfonic acid-derived copolymers with PET (e.g., PET having a high IV and/or a branched PET). The compositions may also be toughened and/or nucleated as described above (e.g., inclusion of 18 weight % EnBAGMA and/or a sodium salt of an organic acid to provide 1000 ppm Na⁺). Although the compositions are generally described herein as containing sodium counterions, other counterions such as lithium, calcium and zinc may be used. Low-melting SIPA-PET copolymers may be particularly useful in some multilayer structures.

“Bulk layer” refers to any layer of a structure that is present for the purpose of increasing the abuse-resistance, toughness, modulus, etc., of a multilayer structure. Bulk layers can comprise polymers that are generally inexpensive relative to other polymers in the structure that provide some specific purpose unrelated to abuse-resistance, modulus, etc.

“Barrier” and “barrier layer”, as applied to multilayer structures, refer to the ability of a structure or layer to serve as a barrier to one or more gases. In the packaging art, oxygen (i.e., gaseous O₂) barrier layers include, e.g., hydrolyzed or saponified ethylene/vinyl acetate copolymer (“HEVA”, also referred to as ethylene/vinyl alcohol copolymer (EVOH)), polyalcohol ethers, polyvinylidene chloride, polyamides, polyacrylonitrile, polyesters, polymerized α-hydroxy acids, aromatic polyesters, resorcinol diacetic acid-based copolyesters, polyalcohol amines, isophthalate-containing polyesters, PEN and PEN copolymers and mixtures thereof, etc., as known to those of skill in the art. These materials may be used neat or further modified to improve their physical properties, such as with the addition of nanoparticles (to improve barrier), such as those available from Nanocor, Southern Clay Products, Rheox and others. These materials can also be pigmented to add additional functionality in aesthetics or light barrier. Fillers such as TiO₂ are useful as a white pigment to provide opacity for protection from UV and visible light. Similarly, carbon black is useful as a black pigment to provide opacity for the same purpose.

“Skin layer” refers to an outside layer of a profiled multilayer structure, this skin layer being subject to abuse.

“Fluid- or product-contact layer” refers to a layer of a multilayer structure such as tubing that is in direct contact with the fluid product being held or transferred in the tubing. In a multilayer structure, a product-contact layer is always an outer layer. The product-contact layer is an inside layer (i.e., innermost layer) of the package, in direct contact with the product.

An interior core layer may include at least one polymeric material selected from the group consisting of polyamides, EVOH, and polyvinylidene chloride, which may be useful for barrier properties. Scavenger materials include products such as BP-Amoco “Amasorb”, and compounds of heavy metals like cobalt with MXD6 nylon (i.e., polyamide based the copolymerization of meta xylene diamine comonomer and adipic acid) or EVOH wherein the cobalt makes the nylon or EVOH reactive to oxygen, as in chemical scavenging reaction therewith, rather than allowing oxygen permeation through the materials. Combinations of barrier materials, such as those above, with such scavengers may provide both barrier and scavenger properties. The incorporation of metal powders in the polymer can provide electromagnetic energy barrier layers, as well. This functionality is in addition to their light filtering functionality.

“EVOH” refers to an ethylene vinyl alcohol copolymer. EVOH includes saponified or hydrolyzed ethylene vinyl acetate copolymers, and refers to a vinyl alcohol copolymer having an ethylene comonomer (EVOH copolymers typically have from 27 to 44 mole % ethylene), and prepared by, for example, hydrolysis of vinyl acetate copolymers. The degree of hydrolysis is preferably from about 50 to 100 mole percent, more preferably from about 85 to 100 mole percent. EVOH is available under the tradename Evalca® from Kuraray and under the tradename Noltex® from Nippon Goshei.

Polyamide can include polyamide 6, polyamide 9, polyamide 10, polyamide 11, polyamide 12, polyamide 6,6, polyamide 6,10, polyamide 6,12, polyamide 6I, polyamide 6T, polyamide 6I 6T, polyamide 6,9, as well as polyamides prepared from terephthalic acid and/or isophthalic acid and trimethylhexamethylenediamine, from adipic acid, azelaic acid, 2,2-bis-(p-aminocyclohexyl)propane, from terephthalic acid and 4,4′-diaminocyclo-hexylmethane, or combinations of two or more thereof.

Polyamides may be made by any method known to one skilled in the art, including the polymerization of a monoamino monocarboxylic acid or a lactam thereof having at least two carbon atoms between the amino group and carboxylic acid group, of substantially equimolar proportions of a diamine which contains at least two carbon atoms between the amino groups and a dicarboxylic acid, or of a monoaminocarboxylic acid or a lactam thereof as define above, together with substantially equimolar portions of a diamine and a dicarboxylic acid. This dicarboxylic acid may be used in the form of a functional derivative thereof, for example, a salt, an ester or acid chloride. See, e.g., U.S. Pat. Nos. 4,755,566; 4,732,938; 4,659,760; and 4,315,086, each also incorporated herein by reference. The polyamide used may also be one or more of those referred to as “toughened nylons,” which are often prepared by blending one or more polyamides with one or more polymeric or copolymeric elastomeric toughening agents. Examples of these types of materials are given in, e.g., U.S. Pat. Nos. 4,174,358; 4,474,927; 4,346,194; 4,251,644; 3,884,882; and 4,147,740, each also incorporated herein by reference. Because such methods are well known, the description of which is omitted herein.

The polyamide includes polyamide 6, polyamide 9, polyamide 10, polyamide 11, polyamide 12, polyamide 6,6, polyamide 6,10, polyamide 6,12, polyamide 6I, polyamide 6T, polyamide 6I 6T, polyamide MXD6 (i.e., polymetaxylene adipate homo- and/or co-polyamides), polyamide 6,9, a copolymer thereof, polyamides prepared from terephthalic acid and/or isophthalic acid and trimethylhexamethylenediamine; from adipic acid, azelaic acid, 2,2-bis-(p-aminocyclohexyl)propane; from adipic acid and m-xylene diamine; and from terephthalic acid and 4,4′-diaminocyclohexyl-methane, or combinations of two or more thereof including polyamide nanocomposites such as those available commercially as Aegis™ from Honeywell or Imperm™ from Mitsubishi Gas Chemicals/Nanocor.

Preferably, the polyamide layer further comprises a polymer that retards the crystallization of the polyamide in the second layer. Preferably, this (crystallization-retarding) polymer comprises at least one material selected from the group consisting of polyolefins and another polyamide having a crystal structure different from the major polyamide in the polyamide layer of the multilayer structure.

Appropriate amounts of various additives can be present in the compositions, and structure layers thereof, including tie layers and the like. The additives include antioxidants, radiation stabilizers, thermal stabilizers, and ultraviolet (UV) light stabilizers, colorants, pigments or dyes, fillers, delustrants such as TiO₂, anti-slip agents, slip agents such as talc, plasticizers, anti-block agents, antistatic agents, other processing aids, elastomers, or combinations of two or more thereof.

The multilayer structure can comprise at least one exterior layer comprising polyester and at least one opaque interior core layer; or at least three layers. The invention is not restricted in the numbers of materials and layers to be molded, but symmetric structures (i.e. having sequences of layers that are identical on both sides of a central core layer) such as 3-, 5- and 7-layer symmetric structures are more common.

An embodiment of a multilayer structure is a two-material, three-layer structure that can be injection molded as a bottle preform and then blow molded into a bottle. In this embodiment, the two exterior layers comprise a polyester composition and the interior layer comprises a different material, such as a barrier material. This interior layer is opaque. For articles such as preforms and bottles, one exterior layer provides the outside surface of the article and the other exterior layer provides the inside surface of the article. The opaque layer may be located preferentially closer to the inside of the preform in order to achieve uniform heating of the preforms.

An embodiment of a two-material, three-layer structure can comprise a structure in which the exterior layers comprise PET, optionally with at least one liquid colorant, white pigment or a combination of liquid colorant and white pigment; and an interior layer comprising an opacifying agent.

Liquid colorants are available from suppliers such as Colormatrix or Holland Colors.

Titanium dioxide (TiO₂) and carbon black are suitable opacifying agents, with TiO₂ preferred since it provides a white color. TiO₂ can also be used as a white pigment in exterior layers.

Examples of such three-layer structures that contain polyester as the polymeric material in both exterior and interior layers include:

(PET+liquid colorant)/(PET+TiO₂)/(PET+liquid colorant);

(clear PET)/(PET+TiO₂+colorant, if desired)/(clear PET); and

(PET+liquid colorant+TiO₂)/(PET+TiO₂+black pigment or liquid colorant)/(PET+liquid colorant+TiO₂).

Other examples of three-layer structures, using non-polyester barrier layers, include:

clear PET/(polyamide+TiO₂+liquid colorant, if desired)/clear PET.

This structure is preferred for recycling of colored bottles. The polyamide layer can be pigmented any color.

Other examples of three-layer structures, include:

clear PET/(EVOH+TiO₂+liquid colorant, if desired)/clear PET;

Pigmented PET/(polyamide+TiO₂+liquid colorant, if desired)/pigmented PET;

Pigmented PET/(EVOH+TiO₂+liquid colorant, if desired)/pigmented PET; and

clear PET/(colored polyamide)/clear PET

clear PET/(ethylene copolymer, e.g., EVA or EMA,+TiO₂+liquid colorant, if desired)/clear PET;

Pigmented PET/(ethylene copolymer, e.g., EVA or EMA,+TiO₂+liquid colorant, if desired)/pigmented PET.

Any of the above could be in 5-layer symmetric structures as well, wherein a layer of the same composition as the exterior layers is a central interior layer with a layer of a different composition between the central interior layer and each exterior layer. The color could be in any or all of the inner layers. For recycling, the color is preferably in layers 2 and/or 4 and in a material such as polyamide or EVOH, which have limited adhesion to the PET.

The invention can be useful also in three-material, five-layer structures where three materials form a five-layer object such as for a plastic container composed of two types of interior layers surrounding a central interior structure layer of a polyester composition; one layer can be selected for its gas barrier or gas scavenger properties, and the other interior layer can be selected for its UV and visible light protection and/or for some other property such as a structural layer or a recycled layer. The exterior layers can comprise a polyester composition. For articles such as preforms and bottles, one exterior layer provides the outside surface of the article and the other exterior layer provides the inside surface of the article. In another embodiment, the barrier layer can also serve as the color/light barrier layer.

One interior core layers can be a humidity sensitive barrier layer within the molded article such as a cylindrical bottle, container or the like. It may shift the barrier layer towards the outside walls of the container, away from the liquid content and thus at a lower relative humidity environment that can enhance the performance of the barrier layer to reduce the volume of barrier material to provide the same barrier effect to the contents. Another illustration is for use of oxygen scavenging layers, the scavenging capacities of which may be increased by being in a higher relative humidity and/or being closer to the contents as opposed to being close to the outside wall. A thicker container outer layer, moreover, may permit less oxygen permeation than if the outer layer were thinner, slowing down oxygen transfer from the outside to the scavenging layer. The scavenging capacity of a scavenging layer closer to the contents would also remove residual oxygen left in the contents of the container during the filling process.

Hot fill bottles are bottles that are filled with heated liquids and the bottle structure may resist to deformation or other deleterious effects when filled with a heated liquid.

Typical hot fill bottles may be PET/high temperature resin/PET or PET/high temperature resin/PET/high temperature resin/PET where the high temperature resin is dimensionally stable at temperatures >180° F. under minimal load. The high temperature resin can be stretched in the orientation range of the PET. Branched PET may help maintain wall distribution when blowing bottles at the high end of the orientation temperature window.

Temperature resistant resins (high temperature resins) include amorphous nylon, such as Selar® PA, available from DuPont and blends of amorphous nylon with other polyamides such as nylon 6, nylon 6,6, polyamide 6I, polyamide 6I,6T, or MXD6 nylon.

Oxygen scavengers can be included in the temperature resistant layer.

A representative for producing a PET container can include (i) injection molding or extrusion molding a closed-bottom hollow preform; (ii) reheating the preform to the blow molding temperature, normally from about 10° C. to 20° C. (18° F. to 36° F.) above the glass transition temperature range of the preform material; (iii) stretching the preform axially in the blow mold by means of a stretch rod; and (iv) simultaneously with the axial stretching, introducing compressed air into the preform so as to biaxially expand the preform outwardly against the walls of the blow mold so that it assumes the desired configuration.

Injection molded preforms adapted for subsequent blow molding into a finally desired container form may include mostly amorphous material allowing the preform to be blow-molded into a desired shape easily and with a minimum of reheating and avoiding the formation of undesirable cracks or haziness in the finished article/preform caused by the presence of excessive crystallized material therein. Further, the article/preform may have an acceptable level of acetaldehyde (a common degradation product of molten polyester), and be free from contaminants or defects.

Injection molding of preforms for later blow molding into container configurations can include some balancing of factors. See, e.g., Blow Molding Handbook, by Rosato and Rosato, Hanser Publishers, New York, N.Y., 1988, the entire handbook is incorporated herein by reference. See also, U.S. Pat. Nos. 5,914,138; 6,596,213; 5,914,138; and 6,596,213, the disclosures of which are incorporated herein by reference.

Injection molding a bottle preform can be conducted by transporting a molten material of the various layers into a mold and allowing the molten materials to cool. The mold includes a first cavity extending inwardly from an outer surface of the mold to an inner end, an article formation cavity, and a gate connecting the first cavity to the article formation cavity. The gate defines an inlet orifice in the inner end of the first cavity, and an outlet orifice that opens into the article formation cavity. The article formation cavity typically may be cylindrical (but other profiles are contemplated) with an axially centered projection at the end opposite the gate. The molten material flows through the gate into the cavity, filling the cavity. The molding may provide an article that is substantially a tube with an “open” end and a “closed” end encompassing a hollow volume. The open end may provide the neck of the bottle and the closed end may provide the base of the bottle after subsequent blow molding. The molding may be such that various flanges and protrusions at the open end provide strengthening ribs and/or closure means, for example screw threads, for a cap. Parison programming to change wall thickness and die shaping to adjust wall distribution, mainly for non-round containers, may be used to modify the resultant parison for improved blow molding performance.

Transporting the material extends from a melt source to the vicinity of the inlet orifice of the gate and includes an elongated bushing residing at least partially within the first cavity. This bushing defines an elongated, axial passageway there through that terminates at a discharge orifice. A “gate area”, therefore, is defined by the assembled mold and bushing between the discharge orifice of the bushing and the outlet orifice of the gate. Ideally, this gate area is the portion of the system/apparatus in which the transition of the material from the molten phase present in the “runnerless” injection apparatus to the glassy phase of the completed article occurs during the time period between sequential “shots” of material.

During the injection of a “shot” of molten material (i.e., melt), the melt can flow from the discharge orifice of the bushing, through the gap between the discharge orifice of the bushing and the inlet of the gate, through the gate, and into the article formation cavity of the mold. Because the temperature is maintained above its maximum crystal melt temperature in the bushing, and the temperature of the mold is maintained well below the minimum glass transition temperature of the material, the majority of each shot cools quickly to its glassy state in the article formation cavity of mold. This results in the preform having low crystallinity levels (i.e., an article made up of substantially amorphous PET or other similar crystallizable polymer) because the material temperature does not remain within its characteristic crystallization range for any appreciable length of time.

At the end of each “shot” injection pressure commonly is maintained on the melt for between about 1 and 5 seconds in order to assure that the melt is appropriately packed into the article formation cavity of the mold. Thereafter, the injection pressure on the melt is released, and the article is allowed to cool in the mold for between about 10 and 20 seconds. Subsequently, the mold is opened, the article is ejected therefrom, and the mold is re-closed. The latter steps take on the order of about 10 seconds. The temperature of the melt material may transition in the gate area of the system/apparatus during the time interval between successive material “shots” between its molten phase temperature and its glassy (rigid) phase temperature in a controlled manner.

For a multilayer preform molding, the molten materials may be injected into the mold from an annular die such that they form a laminar flow of concentric layers. For example, a three-layer preform, the inside layer and the outside layer comprise a polyester composition and the interior layer comprises a different material such as, for example, a barrier material. The molten materials are introduced into the mold such that the material for the outside layer and the inside layer enter the mold cavity before the material for the interior layer enters and form a leading edge of the laminar flow through the cavity. For a period of time, the three layers enter the mold cavity in a three-layer concentric laminar flow. Next, flow of the material for the interior layer is halted and the material for the outside and inside layers provides a trailing edge of the laminar flow. The flow continues until the entire cavity is filled and the trailing edge seals or fuses to itself at the gate area to form the closed end of the preform. The molding process for a three-material, four-layer preform is similar except that two different materials are provided for the two interior layers.

Positioning of the various layers in a cross-section of the preform can be adjusted by controlling relative volumetric flow rates of the inside and outside layers to enable relative shifting of the position of the core, and also the relative thickness of the inside and outside layers in the molded articles (see U.S. Pat. No. 6,596,213).

Molding of three materials to form a four-layer or five-layer object can include a plastic container comprising two interior layers (one layer selected for its gas barrier or gas scavenger properties, and the other layer for its UV protection or for some other property such as a structural layer or a recycled layer). In a 5-layer object, an additional interior structural layer can be between these interior layers. The leading edge of gas barrier and/or gas scavenger property may prefer that one of the two interior layers be uniform in its penetration around the circumference of the molded object. This uniform penetration can be achieved by starting the flow of this one interior layer before starting the flow of the second interior layer, so that the leading edge of this first-flowing interior layer starts on the zero gradient of the velocity profile. Subsequent initiation of the flow of the second interior layer offsets the later-flowing portions of the first interior material from the zero gradient, but the uniform leading edge is established by the initial flow of the first interior layer on the zero gradient.

Such relative thickness and position of each of the interior layers can be chosen to enhance the properties of the final molded object. For example, if one of the interior layers is a gas scavenger, the chosen position of the gas scavenger layer may be the innermost interior layer to reduce the permeation rate of gas through the outer layers of the container into the scavenger, and to increase the rate of gas scavenging from the contents of the container. Such a position may extend the shelf life of the container contents if the purpose of the scavenger layer is to absorb gas permeating from the atmosphere exterior to the container. As another example, the position of outermost interior layer can enhance the performance of a humidity-sensitive gas barrier layer, such as the before-mentioned EVOH or MXD6 nylon, by moving such barrier layer away from the 100% relative humidity of the contents of a beverage that is to fill the container to a position in the wall that is closer to the lower relative humidity of the atmosphere surrounding the container.

Bottles can be manufactured by injection blow molding or extrusion blow molding. To prepare a bottle of this invention, the preform can be reheated and biaxially expanded by simultaneous axial stretching and blowing (as summarized above) in a shaped mold so that it assumes the desired configuration. The neck region is unaffected by the blow molding operation while the bottom and particularly the walls of the preform are stretched and thinned. The resulting thickness of the exterior layers and the interior layers may provide sufficient strength and barrier properties to allow the bottle to contain and protect the product packaged within.

The bottles can be useful for packaging liquids such as carbonated beverages, beer, juices, isotonic beverages, milk and other dairy products, and the like. Carbonated beverages require a barrier that prevents carbon dioxide from permeating out of the bottle. In addition to preventing carbon dioxide from permeating out of the bottle, a beer bottle also requires oxygen and light (especially UV) barriers. In the case of a PET beer bottle even dissolved oxygen in polymer represents a potential taste problem which can be alleviated with oxygen scavenger at as little as 15% of the sulfonic acid comonomer content. Juices and isotonic beverages also require protection from oxygen. Carbonated beverages require a barrier that prevents carbon dioxide from permeating out of the bottle. In addition to preventing carbon dioxide from permeating out of the bottle, a beer bottle also requires oxygen and light (especially UV) barriers. In the case of a PET beer bottle even dissolved oxygen in polymer represents a potential taste problem. Juices and isotonic beverages also require protection from oxygen. Milk requires protection from oxygen and ultraviolet and/or visible light. Other liquids that may be packaged include edible oils, syrups, sauces, purees such as baby foods, and pharmaceuticals. Motor oil, fuels such as gasoline, soaps, detergents, agrochemical products, and the like may also be packaged in bottles of this invention. Powders, granules and other flowable solids may also be packaged in bottles of this invention. Some of the products may be heated when placed into the bottles of this invention (i.e., hot filled).

Although containers are generally described herein as bottles, other containers such as vials, jars, drums and fuel tanks may be prepared as described herein from the compositions and articles of this invention. Other articles, such as toys, panels, furniture and automotive parts may also be prepared similarly.

The following Examples are merely illustrative, and are not to be construed as limiting the scope of the invention.

Unless stated otherwise, all percentages, parts, etc. are by weight.

### EXAMPLES

### Example 1

Materials Used

PET-1: A PET composition having a melt temperature (Tm) of about 247° C. and inherent viscosity of 0.85, available as Lighter™ from Dow Chemical Company;

Liquid colorant;

Opacifying agent: TiO₂

E-1: A composition for the exterior layers of a three-layer multilayer structure was prepared by mixing PET-1 with 1.25 weight % of a white liquid colorant; and

I-1: A composition for the interior layer of a three-layer multilayer structure was prepared by mixing with 1.8 weight % of TiO₂ as the opacifying agent in homopolymer PET.

The exterior composition and interior composition were injection molded as described above using standard conditions to produce a bottle preform having the structure (from outside to inside): E-1/I-1/E-1.

The preforms were blow-molded as described above using standard conditions to provide a blow molded bottle having nominal side-wall thickness of the structure as indicated: E-1 (5 mil)/I-1 (0.5 mil)/E-1 (5 mil).

### Example 2

Materials Used

PET-2: A PET composition having a melt temperature (Tₘ) of about 247° C. and inherent viscosity of 0.85, available as Kosa 1101.

Liquid colorant;

Opacifying agent: TiO₂

E-1: A composition for the exterior layers of a three-layer multilayer structure was prepared by mixing PET-2 with 1.25 weight % of a white liquid colorant; and

I-1: A composition for the interior layer of a three-layer multilayer structure was prepared by mixing homopolymer PET with 10 weight % of TiO₂ as the opacifying agent.

The exterior composition and interior composition were injection molded as described above using standard conditions to produce a bottle preform having the structure (from outside to inside): E-1/I-1/E-1.

The preforms were blow-molded as described above using standard conditions to provide a blow molded bottle having nominal side-wall thickness of the structure as indicated: E-1 (5 mil)/I-1 (0.5 mil)/E-1 (5 mil).

### Example 3

This example shows a multilayer comprising SPET layer/(pigmented polyamide) layer/SPET.

SPET : A sulfonic acid-containing PET which comprises from about 0.001 to about 7, about 0.005 to about 7, or 0,01 to about 5, or about 0.1 to about 2.5, mole % of a sulfonic acid comonomer and optionally an ethylene copolymer, or combinations of two or more thereof. The sulfonic acid includes sulfobenzenedicarboxylic acid, a salt of the acid, an ester of the acid, an ester of the salt, or combinations of two or more thereof. Examples of sulfonic acid-containing polyester includes polyethylene terephthalate 5-sodium sulfoisophthalate terpolymer, a blend of polyethylene terephthalate 5-sodium sulfoisophthalate terpolymer and polyetherester elastomer block copolymer, a blend of polyethylene terephthalate 5-sodium sulfoisophthalate terpolymer and polyethylene terephthalate, a blend of polyethylene terephthalate 5-sodium sulfoisophthalate terpolymer and one or more ethylene copolymer, a blend of polyethylene terephthalate 5-sodium sulfoisophthalate terpolymer and one or more ethylene copolymer. The salt includes calcium salt, zinc salt, lithium salt, sodium salt, or combinations of two or more thereof.

Liquid colorant;

Opacifying agent: TiO₂

E-1: A composition for the exterior layers of a three-layer multilayer structure is prepared by mixing SPET with 1.25 weight % of a white liquid colorant; and

I-1: A composition for the interior layer of a three-layer multilayer structure is prepared by polyamide with 10 weight % of TiO₂ as the opacifying agent.

The exterior composition and interior composition are injection molded as described above using standard conditions to produce a bottle preform having the structure (from outside to inside): SPET/polyamide/SPET.

The preforms are blow-molded as described above using standard conditions to provide a blow molded bottle having nominal side-wall thickness of the structure as indicated: SPET (5 mil)/polyamide (0.5 mil)/SPET (5 mil).

1. A multilayer structure comprising or produced from at least one exterior layer comprising a first polyester and at least one opaque interior core layer comprising a second polyester wherein the core layer optionally includes nucleating agent, modifier, toughener, filler, or combinations of two or more thereof.

2. The multilayer structure of claim 1 wherein the second polyester comprises at least about 65 weight % or about 80 weight % polyethylene terephthalate homopolymer or copolymer.

3. The multilayer structure of claim 2 wherein core layer comprises the filler including TiO₂, carbon black, or combinations thereof.

4. The multilayer structure of claim 3 including (PET+liquid colorant)/(PET+TiO₂)/(PET+liquid colorant); (clear PET)/(PET+TiO₂)/(clear PET); (clear PET)/(PET+TiO₂+colorant)/(clear PET); (PET+liquid colorant+TiO₂)/(PET+TiO₂+black pigment)/(PET+liquid colorant+TiO₂); (PET+liquid colorant+TiO₂)/(PET+TiO₂+liquid colorant)/(PET+liquid colorant+TiO₂), or combinations of two or more thereof wherein PET is polyethylene terephthalate.

5. The multilayer structure of claim 1 wherein the core layer comprises ethylene/vinyl alcohol copolymer, polyvinylidene chloride, polyamide, polyacrylonitrile, aromatic polyester, resorcinol diacetic acid-based copolyesters, isophthalate-containing polyester, polyethylene naphthalate, polyethylene naphthalate copolymer, ethylene vinyl acetate copolymer, ethylene/alkyl (meth)acrylate copolymer, polyolefin, polycarbonate, or combination of two or more thereof; and an opacifying filler.

6. The multilayer structure of claim 5 wherein the core layer comprises at least one polyamide selected from the group consisting of polyamide 6, polyamide 9, polyamide 10, polyamide 11, polyamide 12, polyamide 6,6, polyamide 6,10, polyamide 6,12, polyamide 6/6,6, polyamide 6I, polyamide 6T, polyamide 6I,6T, polyamide 6,9, polyamide MXD6, copolymer of polyamide MXD6, a polyamide nanocomposite, or combinations of two or more thereof.

7. The multilayer structure of claim 6 wherein the core layer comprises polyamide 6, polyamide 6,6, polyamide 6I,6T, polyamide MXD6, polyamide 6/6,6, or combinations of two or more thereof.

8. The multilayer structure of claim 6 wherein the second polyester includes polyethylene terephthalate, polypropylene terephthalate, polybutylene terephthalate, or combinations of two or more thereof; and a least one additional component including nucleating agent, modifier, toughener, filler, or combinations of two or more thereof in which the filler includes TiO₂, carbon black, or combinations thereof.

9. The multilayer structure of claim 8 wherein the polyester is a polyester composition comprising at least about 65 or about 80 wt % polyethylene terephthalate homopolymer or copolymer.

10. The multilayer structure of claim 9 comprising the filler including TiO₂, carbon black, or combinations thereof.

11. The multilayer structure of claim 6 including clear PET/(polyamide+TiO₂)/clear PET; clear PET/(polyamide+TiO₂+liquid colorant)/clear PET; clear PET/(EVOH+TiO₂)/clear PET; clear PET/(EVOH+TiO₂+liquid colorant)/clear PET; Pigmented PET/(polyamide+TiO₂)/pigmented PET; Pigmented PET/( polyamide+TiO₂+liquid colorant)/pigmented PET; Pigmented PET/(EVOH+TiO₂)/pigmented PET; Pigmented PET/(EVOH+TiO₂+liquid colorant)/ pigmented PET; clear PET/(colored polyamide)/clear PET; clear PET/(ethylene copolymer+TiO₂)/clear PET; clear PET/( ethylene copolymer+TiO₂+liquid colorant)/clear PET; Pigmented PET/(ethylene copolymer+TiO₂)/pigmented PET; Pigmented PET/(ethylene copolymer+TiO₂+liquid colorant)/ pigmented PET; or combinations of two or more thereof wherein PET is polyethylene terephthalate and EVOH is polyvinyl alcohol.

12. The multilayer structure of claim 6 comprising PET/high temperature resin/PET or PET/high temperature resin/PET/high temperature resins/PET wherein the high temperature resin includes amorphous nylon; polyamide MXD6; a blend of amorphous nylon and at least one other polyamide including polyamide 6, polyamide 6,6, polyamide 6I, polyamide 6I,6T, or polyamide MXD6; or combinations of two or more thereof wherein PET is polyethylene terephthalate and the high temperature resin layer comprises at least one oxygen scavenger.

13. An article comprising or produced from a multilayer structure wherein the article is an injection molded hollow article, a blown bottle, or combinations thereof and the multilayer structure is as characterized in claim 1.

14. The article of claim 13 wherein the multilayer structure is as characterized in claim 3.

15. The article of claim 13 wherein the multilayer structure is as characterized in claim 4.

16. The article of claim 13 wherein the multilayer structure is as characterized in claim 6.

17. The article of claim 13 wherein the multilayer structure is as characterized in claim 7.

18. The article of claim 13 wherein the multilayer structure is as characterized in claim 8.

19. The article of claim 13 wherein the multilayer structure is as characterized in claim 12.
